(19) United States
(12) Patent Application Publication
(10) Pub. No.: US 2013/0202085 A1
(43) Pub. Date: Aug. 8, 2013

(54) SYSTEM AND METHOD FOR AUTONOMOUS EXPOSURE DETECTION BY DIGITAL X-RAY DETECTOR

(71) Applicants: Scott William Petrick, Sussex, WI (US); Alan Dean Blomeyer, Milwaukee, WI (US); James Zhengshe Liu, Glenview, IL (US); Mark Joseph Alexander, Oconomowoc, WI (US)

(72) Inventors: Scott William Petrick, Sussex, WI (US); Alan Dean Blomeyer, Milwaukee, WI (US); James Zhengshe Liu, Glenview, IL (US); Mark Joseph Alexander, Oconomowoc, WI (US)

(73) Assignee: General Electric Company, Schenectady, NY (US)

(21) Appl. No.: 13/366,105

(22) Filed: Feb. 3, 2012

(51) Int. Cl. G01T 1/24; G01N 23/04

(52) U.S. Cl. 378/62; 250/370.09

(57) ABSTRACT

A digital X-ray detector includes a pixel array that includes multiple pixels arranged in rows and columns, wherein each pixel includes a photodiode and a transistor. The digital X-ray detector also includes a scan line coupled to each pixel in a first dimension, a data line coupled to each pixel in a second dimension, enable circuitry coupled to the transistor of each pixel for enabling readout of the photodiode, and readout circuitry coupled to the photodiode through the transistor of each pixel for reading out data from the photodiode. The digital X-ray detector is configured to autonomously determine a start of an X-ray exposure while the enable circuitry maintains each transistor in an off state.

### BACKGROUND OF THE INVENTION

The subject matter disclosed herein relates generally to X-ray imaging systems, and more particularly to X-ray imaging systems using digital X-ray detectors.

The advent of digital X-ray detectors has brought enhanced workflow and high image quality to medical imaging. However, many of the earlier analog radiographic imaging systems employ conventional X-ray imaging using film cassettes and/or computed radiography (CR) cassettes. There is a desire to upgrade these analog radiographic imaging systems to digital radiographic imaging systems, by replacing the film cassettes or CR cassettes with a digital X-ray detector to improve work flow and image quality. In order to obtain images from these conventional analog X-ray imaging systems, the film cassette or CR cassette must be transported and processed after each exposure, resulting in a time delay in obtaining the desired images. Digital radiography provides an alternative that allows the acquisition of image data and reconstructed images on the spot for quicker viewing and diagnosis, and still allows for images to be readily stored and transmitted to consulting and referring physicians, radiologists and specialists like CR. However, the cost of replacing the earlier conventional radiographic imagining systems with digital radiographic imaging systems may be imposing to a hospital or other medical facility. Consequently, upgrading an analog system with a digital detector would offer a less expensive, more attractive alternative.

The most efficient way to upgrade an analog X-ray imaging system to a digital X-ray imaging system is to not change anything in the analog X-ray imaging system, but to add a digital X-ray detector that works independent of the analog X-ray imaging system just like film cassettes or CR cassettes. In order for a digital X-ray detector to work independent of the analog X-ray imaging system, the digital X-ray detector must always be ready to receive X-rays and have the ability to detect when an X-ray exposure starts and when the X-ray exposure ends.

The subject matter of this disclosure obviates the need to couple the digital X-ray detector to an X-ray imaging system for the purpose of controlling the detector's behavior, such as power management, preparing the detector for receiving X-rays, reading the detector and scrubbing the detector, both before and after an X-ray exposure.

Therefore, there is a need for a digital X-ray detector to provide autonomous X-ray exposure detection and image acquisition management in an X-ray imaging system.

### BRIEF DESCRIPTION OF THE INVENTION

In accordance with an aspect of the present disclosure, a digital X-ray detector includes a pixel array that includes multiple pixels arranged in two dimensions, wherein each pixel includes a photodiode and a transistor. The digital X-ray detector also include a scan line coupled to each pixel in a first dimension, a data line coupled to each pixel in a second dimension, enable circuitry coupled to the transistor of each pixel for enabling readout of the photodiode, and readout circuitry coupled to the photodiode through the transistor of each pixel for reading out data from the photodiode. The digital X-ray detector is configured to autonomously determine a start of an X-ray exposure while the enable circuitry maintains each transistor in an off state.

In accordance with an aspect of the present disclosure, an X-ray imaging system includes an X-ray radiation source, a source controller coupled to the X-ray radiation source and configured to command X-ray emission of X-ray radiation for X-ray exposures, and a digital X-ray detector. The digital X-ray detector includes a pixel array that includes multiple pixels, wherein each pixel includes a photodiode and a transistor. The digital X-ray detector also includes enable circuitry coupled to the transistor of each pixel for enabling readout of the photodiode and readout circuitry coupled to the photodiode through the transistor of each pixel for reading out data from the photodiode. The digital X-ray detector is configured to determine a start of an X-ray exposure, without communication of exposure timing signals from the source controller, while the enable circuitry maintains each transistor in an off state.

In accordance with an aspect of the present disclosure, an X-ray imaging method includes a digital X-ray detector that includes a pixel array that includes multiple pixels arranged in two dimensions, wherein each pixel includes a photodiode and a transistor, a scan line coupled to each pixel in a first dimension, enable circuitry coupled to the transistor of each pixel for enabling readout of the photodiode, readout circuitry coupled to the photodiode through the transistor of each pixel for reading out data from the photodiode, and the digital X-ray detector is configured to autonomously perform the following steps. The steps include starting a timer upon completion of scrubbing, acquiring phantom data samples via the readout circuitry and generating a non-exposure baseline based on the phantom data from these first set of samples, after which the detector signals to the operator that it is ready for exposure. The steps also include, upon generating the non-exposure baseline, acquiring data samples via the readout circuitry and determining a start and end of the X-ray exposure by comparing a level of a signal from the data acquired for each subsequent sample to the non-exposure baseline. The steps further include storing a first timer value indicating the start of the X-ray exposure, if the level of the signal of the subsequent samples is equal to or greater than an amplitude threshold above the non-exposure baseline for at least a first temporal threshold, or conversely, consecutive number of samples. The steps yet further include storing a second timer value indicating the end of the X-ray exposure, if the level of the signal of the subsequent samples returns to less than the amplitude threshold above the non-exposure baseline for at least a second temporal threshold or consecutive number of samples. The steps still further include acquiring image data from the detector. This image data is integrated by the detector during the X-ray exposure to generate an exposure image.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an exemplary embodiment of an X-ray imaging system;

FIG. 2 is a schematic diagram of an exemplary embodiment of the functional components of a digital X-ray detector;

FIG. 3 is a schematic diagram of an exemplary embodiment of readout electronics and a single pixel acquisition process of a digital X-ray detector;

FIGS. 4A-4C are a flow diagram of an exemplary embodiment of an X-ray imaging method;

FIG. 5 is a schematic diagram of an exemplary embodiment of the pixel summation and comparison logic of a digital X-ray detector;

FIG. 6 is a representation of phantom data from a digital X-ray detector during which two short exposures were captured; and

FIG. 7 is a graph of the phantom data from FIG. 6, wherein each data point in the graph represents the summation of all the values along each horizontal line in FIG. 6.

### DETAILED DESCRIPTION OF THE INVENTION

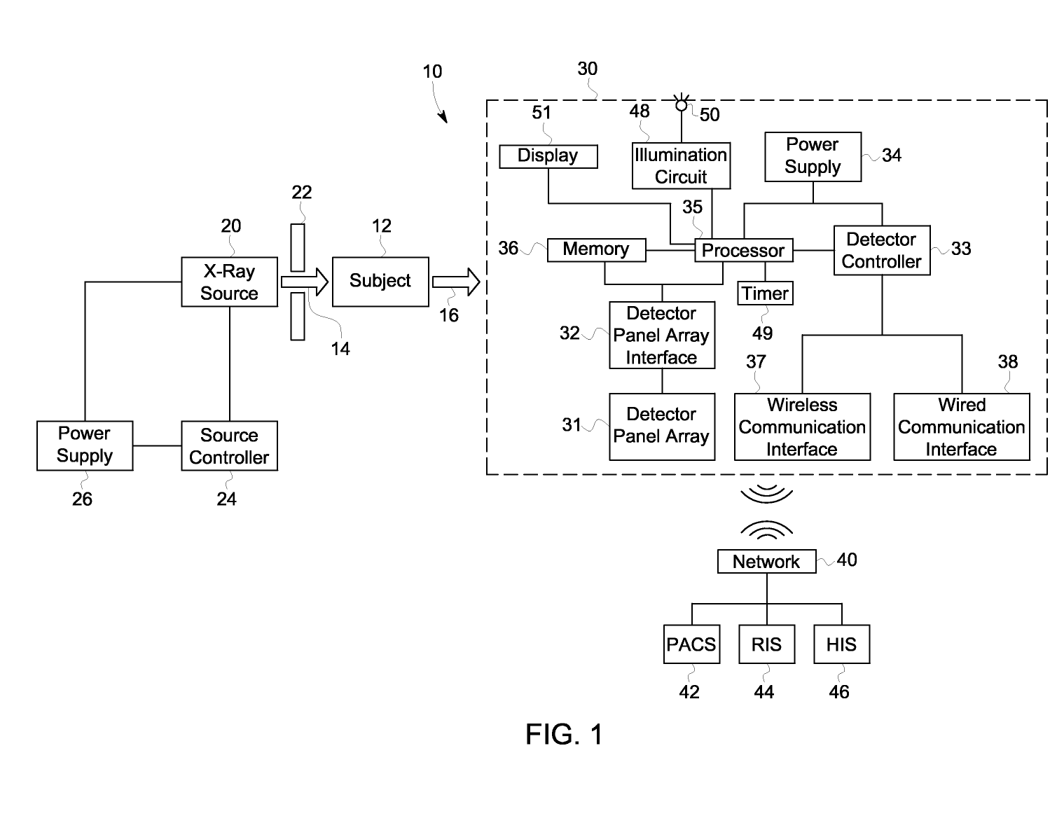

Referring generally to FIG. 1, an X-ray imaging system is represented and referenced generally by reference numeral 10. In the illustrated embodiment, the X-ray imaging system 10, as adapted, is a digital X-ray imaging system. The X-ray imaging system 10 is designed both to acquire image data and to process the image data for display in accordance with the present technique. Throughout the following discussion, however, while basic and background information is provided on the digital X-ray imaging system used in medical diagnostic applications, it should be born in mind that aspects of the present techniques may be applied to digital X-ray detectors, including X-ray detectors, used in different settings (e.g., projection X-ray imaging, computed tomography imaging, tomosynthesis imaging, fluoroscopic imaging, radiographic imaging, etc.) and for different purposes (e.g., parcel, baggage, vehicle and component inspection, etc.).

In the embodiment illustrated in FIG. 1, the X-ray imaging system 10 may be a conventional analog X-ray imaging system, retrofitted for digital image data acquisition and processing as described below. In one embodiment, the X-ray imaging system 10 may be a stationary X-ray imaging system disposed in a fixed X-ray imaging room. It will be appreciated, however, that the presently disclosed techniques may also be employed with other X-ray imaging systems, including a mobile X-ray imaging system in other embodiments.

The X-ray imaging system 10 includes an X-ray source 20 positioned adjacent to a collimator 22. Collimator 22 permits a beam of X-ray radiation 14 to pass into a region in which a subject 12, such as a human patient, an animal or an object, is positioned. A portion of the X-ray radiation 16 passes through or around the subject 12 and impacts a digital X-ray detector 30. As described more fully below, the digital X-ray detector 30 converts X-ray photons received on the surface of a detector panel array 31 to lower energy photons, and subsequently to electric signals which are acquired and processed to reconstruct an image of the features within the subject 12.

The X-ray source 20 is coupled to a power supply 26 which furnishes power for imaging examination sequences. The X-ray source 20 and power supply 26 are coupled to a source controller 24 configured to command X-ray emission of X-rays for image exposures. As mentioned above, the digital X-ray detector 30 is configured to acquire X-ray image data without communication from the X-ray source 20 or source controller 24. In other words, the digital X-ray detector 30 is without communication of timing signals from the X-ray source 20, source controller 24 or other system controller as to the start and end of an X-ray exposure. As a result, the digital X-ray detector 30 is configured to autonomously determine the start and end of an X-ray exposure as well as to autonomously regulate other operations of the detector 30 associated with detecting the X-ray exposure. For example, as described in greater detail below, the digital X-ray detector 30 may compare data acquired through the pixel array of the detector 30 prior to, during, and after an exposure to determine the occurrence of the exposure. In certain embodiments, the digital X-ray detector 30 may determine the start and end of the X-ray exposure, while the enable circuitry maintains each transistor in an off state.

The digital X-ray detector 30 includes a detector panel array 31 that includes a pixel array of light sensing photodiodes and switching thin film field-effect transistors (FETs) that convert light photons to electrical signals. A scintillator material deposited over the pixel array of photodiodes and FETs converts incident X-ray radiation photons received on the scintillator material surface to lower energy light photons. As mentioned above, the pixel array of photodiodes and FETs converts the light photons to electrical signals. Alternatively, the detector panel array 31 may convert the X-ray photons directly to electrical signals. The electrical signals are converted from analog signals to digital signals by a detector panel array interface 32 which provides the digital signals to a processor 35 to be converted to image data and reconstructed into an image of the features within the subject 12.

The digital X-ray detector 30 further includes a detector controller 33 which coordinates the control of the various detector functions. For example, detector controller 33 may execute various signal processing and filtration functions, such as for initial adjustment of dynamic ranges, interleaving of digital image data, and so forth. The detector controller 33 is coupled to processor 35. The processor 35, the detector controller 33, and all of the electronics and circuitry within the digital X-ray detector 30 receive power from a power supply 34. The power supply 34 may include one or more batteries.

The processor 35 is also linked to an illumination circuit 48. The detector controller 33 may send a signal to the processor 35 to signal the illumination circuit 48 to illuminate a light 50 (e.g., light emitting diode) to indicate the detector 30 is prepared to receive an X-ray exposure upon powering up, initialization, and scrubbing. Indeed, the detector 30 may be turned on or awoken from an idle state by the user (e.g., pressing an on/off button located on the detector 30). Further, the processor 35 may signal the illumination circuit 48 to illuminate the light 50 to alert the operator that a max time has elapsed without the detector 30 detecting an exposure or a max exposure time has elapsed for a detected exposure. Yet further, the processor 35 is linked to a display 51 (e.g., LED display) to provide a visual indication of the status of the detector 30 and/or an exposure. Still further, the processor 35 is linked to a timer 49 to monitor times for multiple purposes as described in greater detail below.

The processor 35 and detector panel array interface 32 are coupled to a memory 36. The memory 36 may store various configuration parameters, calibration files, and detector identification data. In addition, the memory 36 may store patient information to be combined with the image data to generate a DICOM compliant data file. Further, the memory 36 may store sampled data gathered prior to and during an X-ray exposure as well as X-ray image data. Yet further, the memory 36 may store timer values and thresholds as described in greater detail below.

The digital X-ray detector 30 includes a wireless communication interface 37 for wireless communication with a network 40, as well as a wired communication interface 38, for communicating with the network 40 when it is tethered to it. The digital X-ray detector 30 may be configured to wirelessly transmit or transmit through a wired connection partially processed or fully processed X-ray image data to a network 40. The digital X-ray detector 30 may also be in communication with an image review and storage system over the network 40 via the wired or wireless connection. The image review and storage system may include a picture archiving and communication system (PACS) 42, a radiology information system (RIS) 44, and/or a hospital information system (HIS) 46. In an exemplary embodiment, the image review and storage system may process the X-ray image data. The wireless communication interface 37 may utilize any suitable wireless communication protocol, such as an ultra wideband (UWB) communication standard, a Bluetooth communication standard, or any IEEE 802.11 communication standard. The digital X-ray detector 30 may also be configured to transmit, via a wired or wireless connection, unprocessed or partially processed image data to a workstation or a portable detector control device or transmit processed X-ray images to a printer to generate a copy of the image.

The portable detector control device may include a personal digital assistant (PDA), palmtop computer, laptop computer, smart telephone, tablet computer such as an iPad™, or any suitable general purpose or dedicated portable interface device. The portable detector control device is configured to be held by a user and to communicate wirelessly with the digital X-ray detector 30. It is noted that the detector and portable detector control device may utilize any suitable wireless communication protocol, such as an IEEE 802.15.4 protocol, an UWB communication standard, a Bluetooth communication standard, or any IEEE 802.11 communication standard. Alternatively, the portable detector control device may be configured to be tethered or detachably tethered to the digital X-ray detector 30 to communicate via a wired connection.

In an exemplary embodiment, the digital X-ray detector 30 may be configured to at least partially process the X-ray image data. Alternatively, the raw image data may be sent from the digital X-ray detector 30 to a remote processor to process the X-ray image data. However, in certain embodiments, the digital X-ray detector 30 may be configured to fully process the X-ray image data itself. Also, the digital X-ray detector 30 may be configured to generate a DICOM compliant data file based upon the X-ray image data, patient information and other information. In an exemplary embodiment, the patient information may be transferred from a patient database via a wireless or wired connection from a network or workstation to the digital X-ray detector 30.

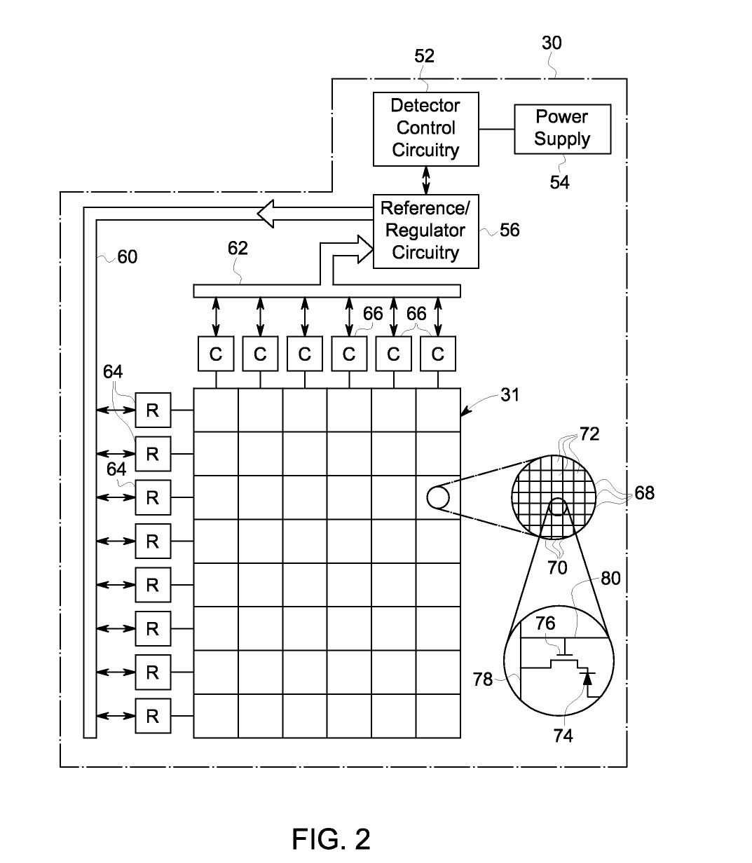

FIG. 2 illustrates a detailed block diagram of an exemplary embodiment of the functional components of the digital X-ray detector 30. As illustrated, detector control circuitry 52 receives DC power from a power supply 54. Detector control circuitry 52 is configured to originate timing and control commands for scan and readout electronics used to acquire image data during data acquisition phases of operation of the X-ray imaging system. The detector control circuitry 52 therefore transmits power and control signals to reference/regulator circuitry 56, and receives image data from reference/regulator circuitry 56.

In a present embodiment, digital X-ray detector 30 includes a scintillator material that converts X-ray radiation photons received on the detector panel array surface during X-ray examinations to lower energy light photons. An array of photodetectors then converts the light photons to electrical signals which are representative of the number of light photons or therefore the intensity of radiation impacting individual pixel regions or picture elements on the detector panel array surface. In an exemplary embodiment, the X-ray radiation photons may be directly converted to electrical signals. Readout electronics convert the resulting analog signals to digital signals that can be processed, stored, and displayed, following reconstruction of an image. As mentioned above, the array of photodetectors or discrete picture elements is organized in rows (e.g., first dimension) and columns (e.g., second dimension), with each discrete picture element consisting of a photodiode and a thin film field effect transistor (FET). The cathode of each photodiode is connected to the source of the FET, and the anodes of all the photodiodes are connected to a negative bias voltage (e.g., via a common electrode). The gates of the FETs in each row are connected together on a single scan line or scan electrode and scan electrodes are connected to scanning electronics as described below. The drains of the FETs in a column are connected together and the data line or data electrode of each column is connected to an individual channel of the readout electronics.

As described in greater detail below, the detector control circuitry 52 is configured to monitor and determine the start and end of an X-ray exposure. In addition, the detector control circuitry 52 is configured to manage the power of the detector 30 and to regulate the interaction between the scrubbing of the detector 30 and determining the start and end of the X-ray exposure. Further, the detector control circuitry 52 is configured to sample data from the detector 30 during or after receipt of X-ray radiation.

Turning back to the embodiment illustrated in FIG. 2, by way of example, a scan bus 60 includes a plurality of conductors for enabling readout from various rows of the digital X-ray detector 30, as well as for disabling rows and applying a charge compensation voltage to selected rows, where desired. A data control bus 62 includes additional conductors for commanding readout from the columns either while the FETs of each of the rows are sequentially enabled (i.e. “scanned”), which constitutes actual image acquisition, or while all the FETs are held in the “off” state continuously, during which phantom data is acquired. Scan bus 60 is coupled to enable circuitry and a series of scan drivers 64, which are used to enable the FETs of a series of rows in the digital X-ray detector 30. Similarly, readout electronics 66 are coupled to data control bus 62 for commanding readout of some or all columns of the digital X-ray detector 30.

In the illustrated embodiment, scan drivers 64 and readout electronics 66 are coupled to a detector panel 31 which may be subdivided into a plurality of rows 68, columns 70 and pixels 72. The FETs of each row 68 are coupled to one of the scan drivers 64. Similarly, the drain electrode of each FET along each column 70 is coupled to readout electronics 66. The photodiode 74 and thin film FET 76 arrangement mentioned above thereby define an array of pixels or discrete picture elements 72 which are arranged in rows 68 and columns 70.

As also illustrated in FIG. 2, each picture element 72 is generally defined at a row 68 and column 70 crossing, at which a data electrode 78 crosses a scan electrode 80. As mentioned above, a FET 76 is provided at each crossing location for each picture element 72, as is a photodiode 74. As the FETs along each row 68 are enabled by scan drivers 64, signals from each photodiode 74 may be accessed via readout electronics 66, and converted to digital signals for subsequent processing and image reconstruction. Thus, an entire row 68 of pixels 72 in the array panel 31 is controlled simultaneously when a scan electrode 80 attached to the gates of all the FETs 76 of pixels 72 on that row 68 is activated. Consequently, each of the pixels 72 in that particular row 68 is connected to a data electrode 78, through a switch, i.e. the FET which is used by the readout electronics 66 to restore charge to the photodiode 74.

It should be noted that in certain systems, as the charge is restored to all the picture elements 72 in a row simultaneously by each of the associated dedicated readout channels, the readout electronics is converting the measurements from the previous row from an analog voltage to a digital value. Furthermore, the readout electronics may transfer the digital values from rows previous to the acquisition subsystem, which will perform some processing prior to displaying a diagnostic image on a monitor or writing it to film.

The circuitry used to enable the FETs along each row may be referred to in a present context as scan enable circuitry. The FETs associated with the scan enable circuitry described above are placed in an “on” or conducting state for enabling the FETs in a given row, and are turned “off” or placed in a non-conducting state when the FETs are not enabled for readout. Despite such language, it should be noted that the particular circuit components used for the scan drivers and column readout electronics may vary, and the present invention is not limited to the use of FETs or any particular circuit components.

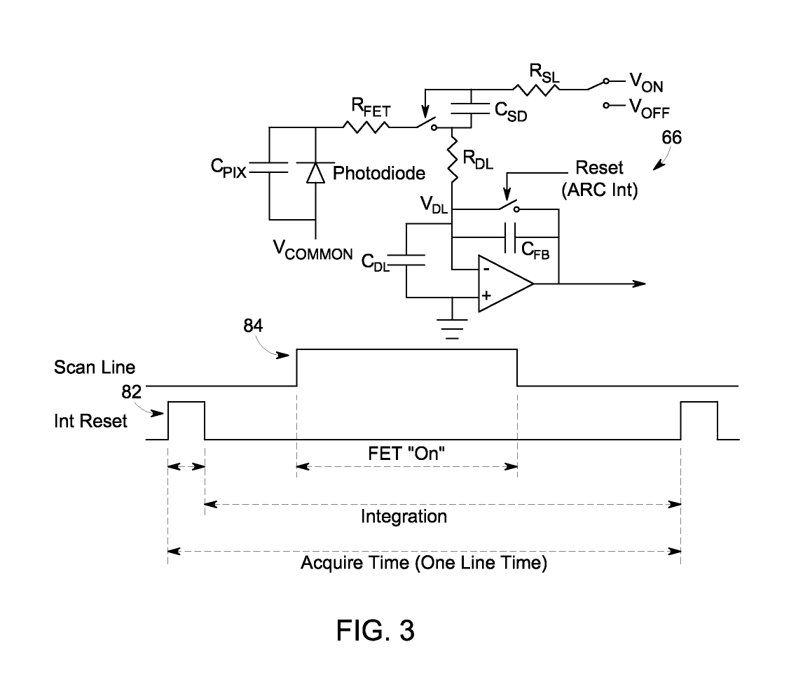

FIG. 3 is a schematic diagram of a single pixel, the front end of the readout electronics 66 (e.g., Application Specific Integrated Circuit (ASIC)), the output of one of the scan drivers and a single pixel acquisition process of the digital X-ray detector 30. Typically the scan and readout circuits in a solid state x-ray detector can be operated independently. However, to produce a diagnostic image, they are operated in synchronism with one another. For example, the read out circuits 66 will be reset (Int Reset is “high” as indicated by reference numeral 82) prior to the activation of a scan line and will begin to integrate the signal seen on the data lines. Shortly after, a scan line is activated (FET “On” as indicated by reference numeral 84) and is held active for some small period of time, which allows the bias across the photodiode to be restored to the exact same potential that it was prior to an exposure. A short time after the scan line is deactivated, the integration process is stopped and the integrated signal is ready to be converted to a digital quantity, for example, all of which is depicted in FIG. 3.

However, there are times that the scan and read out circuits may be operated independently. As mentioned above, the digital X-ray detector 30 is without communication from the X-ray source 20 and the source controller 24 and, thus, is without a priori knowledge of the beginning and ending times of an X-ray exposure. Operating the scan and read out circuits independent of each other (i.e., asynchronously), along with intelligently classifying the resulting data according to its amplitude relative to similar data acquired when the detector 30 is not being subjected to an X-ray exposure, enables the detector to determine start and end of the X-ray exposure. In the present disclosure and as will be described in more detail below, the digital X-ray detector 30 is configured to autonomously detect the start and end of the X-ray exposure automatically.

For example, the scan circuits can be held off and the read out circuits can be cycled to collect “real time” data in order for the detector 30 to decide for itself that it has been exposed to X-rays, that the exposure has been completed, and that it is therefore time to read the detector 30 so that a diagnostic image can be formed, stored for diagnosis, and the detector 30 can then be made ready for subsequent exposures. Referring again to FIG. 3, phantom data is generated when the scan line is held “low” (off) and does not transition at 84 the way that it is shown. Because the detector 30 is not perfect, signal will leak through the transistors, which are photoconductive even though they are electrically held in the off state. A small amount of signal will leak from every pixel that is being exposed, and all of this signal along a given data line will effectively add together. This cumulative signal can be sampled and converted by the readout electronics coupled to each data line to produce phantom data which will have no positional information along the data line and hence is therefore only temporal in nature. Even though the transistors leak most of the signal is retained by the photodiodes during the exposure. At the conclusion of the exposure, the transistors are no longer subjected to light and return to their normal “baseline” leakage, and the photodiodes will retain the majority of their individual signal that was integrated for the entire time that the transistor was held in the “off state”.

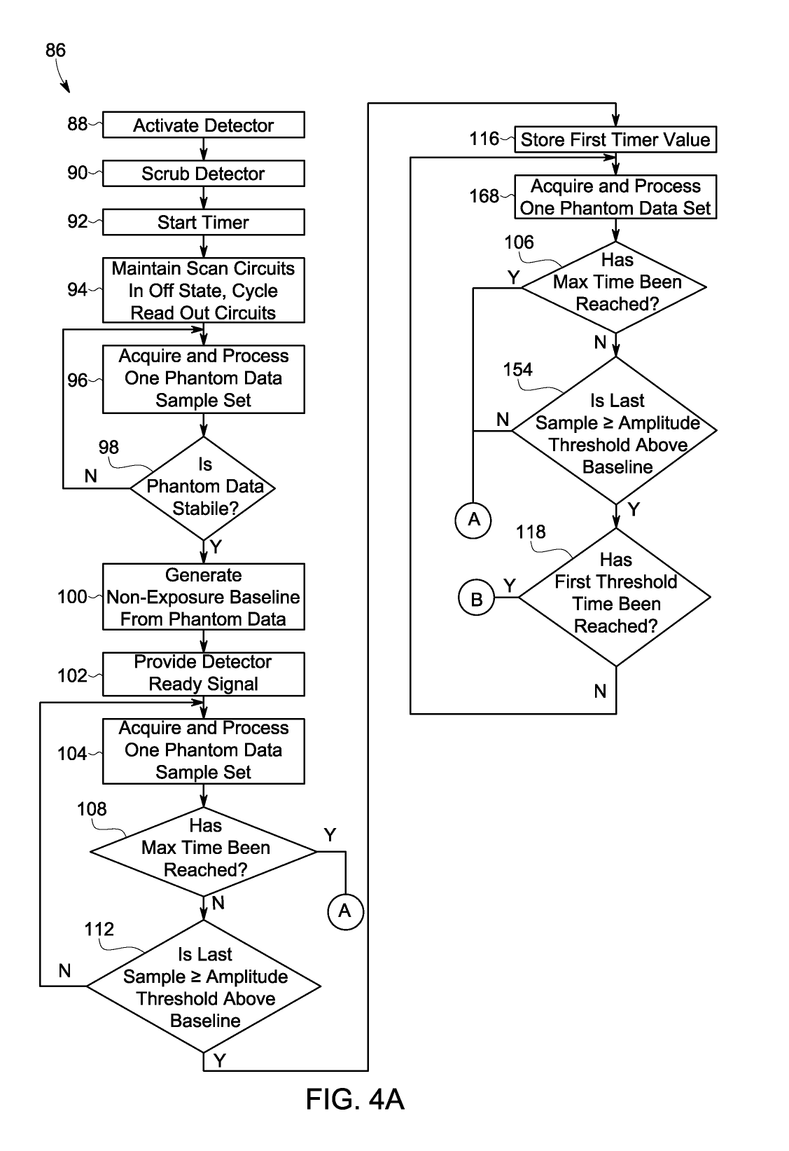

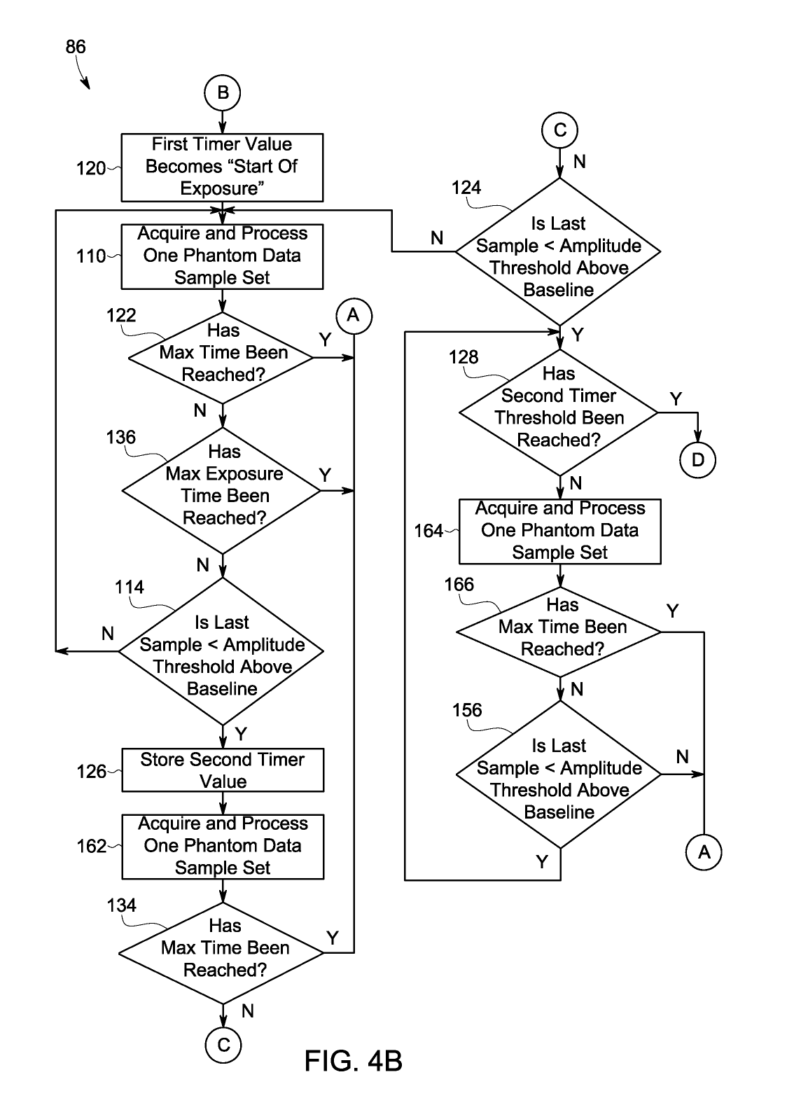

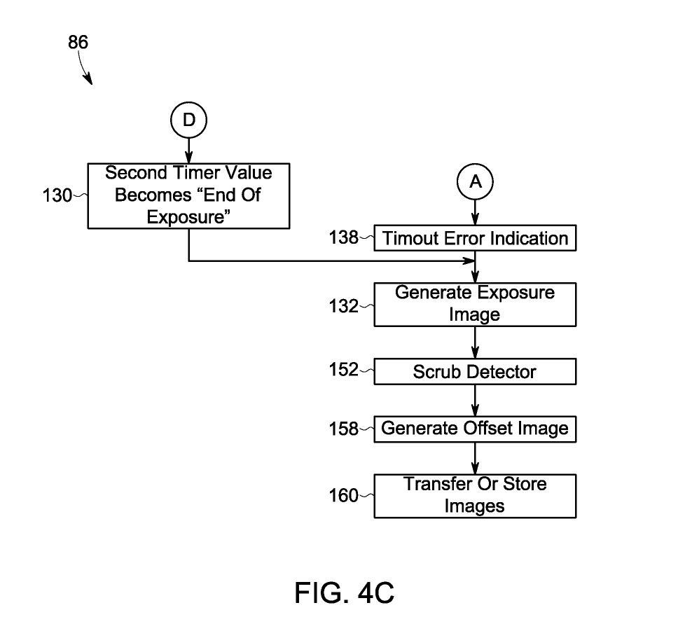

FIGS. 4A-4C illustrate a method 86 for the detector 30 to autonomously determine the start and end of an X-ray exposure. The method 86 includes the operator activating the detector 30 from an off state or idle state by activating a wake or power on button (block 88). Upon the detector 30 powering up and performing initialization, the detector 30 scrubs itself (i.e., to prepare and refresh the detector circuitry) a finite number of times (e.g., 4 frames) (block 90). After completing the last scrub, the detector 30 starts the timer 49 for use for multiple purposes as described below (block 92). The detector 30 (i.e., enable circuitry) maintains the scan circuits (i.e., transistors) in an “off” or non-conducting state and begins cycling the readout circuits to enable the detector 30 to acquire data to be used later as the baseline in determining whether or not the detector is being exposed to X-rays (block 94). In particular, the readout circuitry (66) is continuously read, in the powered state, to determine the “non-exposure,” “non-reading” (i.e., scanning is not enabled) offset.

For each reading (e.g., phantom line), the detector 30 acquires data (e.g., phantom data) and processes the phantom data for one phantom data sample set (block 96). It is known that at this particular time, the phantom data lacks any information or data related to an X-ray exposure, because it is prior to the time that the detector 30 has indicated to the operator that exposures are allowed. As part of the processing, the detector 30 examines the data (e.g., phantom data) to see if stability has been achieved (block 98). If the phantom data is not stable, the detector 30 continues to acquire and process phantom data (block 96) and to determine if the phantom data is stable (block 98). Once stability has been achieved, the detector 30 generates a non-exposure baseline from the phantom data (block 100). In certain embodiments, the detector 30 averages the data (e.g., phantom data) from N phantom lines to generate a non-exposure baseline. For example, the current offset value for the non-exposure baseline corresponds to zero exposure. While the detector 30 maintains the scan circuits in the off state and operates (i.e., cycles) the read out circuits as described above, the best and most autonomous results will be obtained when the detector 30 uses the signal from every data line. This is true because the detector is a portable detector operating independently of the X-ray system and lacking a priori information regarding where (across the entrance plane of the detector 30) to expect the X-ray exposure. The X-ray exposure could occur at any part of the detector 30, so the whole detector 30 will need to be examined. Alternatively, a section of the detector 30 that must always be exposed can be defined, and then only those data lines from that section need be used in determining the occurrence and timing of an exposure. One means to process either a whole or part phantom line would be by taking the converted (digital) data from every channel desired and averaging the output “across” a phantom scan line. In effect each individual channel samples each individual data line at exactly the same instant in time during a “line,” even phantom ones. Alternatively, the detector 30 sums the desired data across the (phantom) scan line, thus avoiding the complexity of having to divide by the number of data lines summed. Dividing by the number of data lines is much simpler if that number happens to be a power of two. That division can be accomplished by right shifting the (binary) sum by the number of bits needed to represent the number of data lines. For example, if the detector 30 included 2048 data lines, the sum can be divided to form an average by right shifting it by 11 bits, since 2¹¹=2048. The only penalty for using the sum is that more bits will be required when it is used in a comparison, or when a threshold value is added to it.

Upon generating the non-exposure baseline (block 100), the detector 30 signals the operator that the detector 30 is ready for an exposure (block 102). The signal may be provided via the light 50 or display 51 described above. In addition, the detector 30 continues to maintain the scan circuits (i.e., transistors) in an “off” or non-conducting state and continues cycling the readout circuits to enable the detector 30 to determine the start and end of an X-ray exposure, the continuation of which is indicated by block 104.

Upon receiving the ready signal, the operator activates the prep and expose signals on the X-ray system to begin the exposure, which is not shown, but occurs any time after block 102. On a continuous basis, the detector 30 monitors the timer 49 to ensure a “max time on” has not been reached prior to the start of the X-ray exposure. Thus, the detector 30 must determine if the “max time on” is reached (block 108). If the detector 30 determines the “max time on” has been reached, the detector 30 provides an indication that a timeout error has been generated via the light 50 or display 51 to the operator (starting from block 138) and the detector 30 proceeds to read itself as if an exposure had been detected as a precaution so that no image information is lost in any event and the operator can later choose to discard the image data at some later time.

If the detector 30 determines the “max time on” has not been reached, the detector 30 continues to compare the level of a signal derived from the data acquired to the non-exposure baseline to determine the start of the X-ray exposure. Specifically, the detector 30 determines whether the signal is equal to or greater than an amplitude threshold above the non-exposure baseline (block 112). In certain embodiments, the amplitude threshold, which is experimentally characterized, represents the minimum signal level above the non-exposure baseline needed to be interpreted as evidence of exposure. Because the non-exposure baseline is obtained during the current operation, it will reflect the effect of temperature and other temporal conditions that will potentially be different from not only detector to detector but from operation to operation for a given detector as well. As such, detector operation will be less sensitive to the fluctuation of these conditions than if a single number representing both the minimum exposure signal level and non-exposure baseline were defined for all detectors under all conditions. If the signal is not equal to or greater than the amplitude threshold above the non-exposure baseline, the detector 30 continues to compare the level of the signal derived from the data acquired to the non-exposure baseline (blocks 104 and 112). If the signal is equal to or greater than the amplitude threshold above the non-exposure baseline, the detector 30 determines the X-ray exposure may have begun and stores a first timer value of when the X-ray exposure may have begun in a temporary location (block 116).

Upon storing the first timer value, the detector 30 continues to monitor the data reading by phantom reading and makes a determination of whether the level of the signal is equal to or greater than the amplitude threshold above the non-exposure baseline for at least a first temporal threshold (block 118). The first temporal threshold is described in greater detail below. If the first temporal threshold is not met, the detector 30 acquires and processes the data (block 168) continues to compare the level of the signal derived from the data acquired to the non-exposure baseline (block 154). In addition, on a continuous basis, the detector 30 monitors the timer 49 to ensure a “max time on” has not been reached prior to determining the start of the X-ray exposure. Thus, the detector 30 must determine if the “max time on” is reached (block 106). If the detector 30 determines the “max time on” has been reached or that first temporal threshold is not met, the detector 30 provides an indication that a timeout error has been generated via the light 50 or display 51 to the operator (starting from block 138) and the detector 30 proceeds to read itself as if an exposure had been detected as a precaution so that no image information is lost in any event and the operator can later choose to discard the image data at some later time. If the first temporal threshold is met, the detector 30 concludes the X-ray exposure has begun and recognizes the first timer value as the start of the of exposure value (block 120).

After recognizing the start of the exposure, the detector 30 continues acquire phantom data, as indicated by block 110 and will compare the level of the signal from the acquired data to the non-exposure baseline (block 114) to determine the end of the X-ray exposure. Strictly for the sake of brevity and clarity, the FIGS. 4A-4C have been constructed to minimize the number of individual blocks that represent the individual steps the detector performs while making the exposure determination. Consequently, two separate tests have been shown prior to the amplitude comparison (block 114). In block 122, similar to block 108, the timer maximum is being tested. In block 136, the maximum exposure time is being tested. Under normal circumstances, the detector will “fail” both of those tests and arrive at block 114, where specifically, the detector 30 determines whether the signal is less than the amplitude threshold above the non-exposure baseline. If the signal is not less than the amplitude threshold above the non-exposure baseline, the detector 30 continues to compare the level of the signal derived from the data acquired to the non-exposure baseline (blocks 110 and 114). If the signal is less than the amplitude threshold above the non-exposure baseline, the detector 30 determines that the X-ray exposure may have ended or completed and stores a second timer value of when the X-ray exposure may have ended in a temporary location (block 126). If either test for “max time on” or “max expose time” passes, the generic timeout error is indicated and the detector proceeds from block 138 as indicated earlier.

Upon storing the second timer value, the detector 30 continues to monitor the data reading by phantom reading starting as indicated by block 162. In addition, in block 134, the timer maximum is tested similar to blocks 108 and 122. Further, the detector 30 makes a determination of whether the level of the signal is less than the amplitude threshold above the non-exposure baseline (block 124) for at least a second temporal threshold (block 128). The second temporal threshold is described in greater detail below. If the second temporal threshold is not met, the detector 30 continues to compare the level of the signal derived from the data acquired to the non-exposure baseline, starting as indicated by block 164, as indicated above. If the second temporal threshold is met, the detector 30 concludes the X-ray exposure has ended or completed and recognizes the second timer value as the end of exposure value (block 130). Upon recognizing the completion of the exposure, the detector 30 generates an exposure image (i.e., a single imaging frame) by reading the X-ray exposure data integrated by the individual pixels of the detector 30 (block 132). In particular, the detector 30 once again operates the scan (e.g., enable circuitry) and read out circuits in synchronization. In addition, the ability to acquire the exposure image in a single read or in a single imaging frame, as opposed to combining image data from multiple imaging frames, reduces the amount of noise in the reconstructed image.

Once the start of the exposure is recognized (block 120), just as the detector 30 continues to regularly compare the level of the signal to the non-exposure baseline (block 114), the detector 30 also regularly monitors the timer 49 to determine whether a length of the exposure does not surpass a predetermined maximum or “max exposure time” (block 136). If the detector 30 determines the “max exposure time” has not been met, the detector 30 continues to compare the level of the signal to the non-exposure baseline (block 114). If the detector 30 determines the “max exposure time” has been met, the detector 30 provides an indication to the operator that a generic timeout error has occurred via the light 50 or display 51 of the detector 30 (block 138). In addition, upon meeting the “max exposure time,” the detector generates an exposure image (block 132) as if the X-ray exposure has been completed.

Upon generating the exposure image (block 132), the detector 30 scrubs itself (block 152) the same number of finite times as before (i.e., block 90). In addition, the detector 30 generates an offset (i.e., dark) image in a similar manner to that used to acquire the exposure image (block 158). In other words, the detector 30 maintains the scan circuits (i.e., transistors) in an off state, cycles the read out circuits, and restarts the timer 49. Once the timer 49 reaches the end of the exposure value (e.g., derived from block 130), the detector 30 reads itself to acquire the offset image (block 158). The offset image is used to correct (e.g., for non-zero data in the absence of X-ray, such as that produced by photodiode leakage) the exposure image as part of the processing required to produce a diagnostic quality image. Prior to the detector 30 going to sleep or turning itself off, the detector 30 transfers the images to an external archive (e.g., PACS, RIS, HIS) or stores them locally inside the detector in the non-volatile memory 36 (block 160). As mentioned above, the image data may be unprocessed, partially processed, or completely processed prior to transfer of image data to the workstation, a portable detector control device, or external archive, or prior to storage on the detector 30.

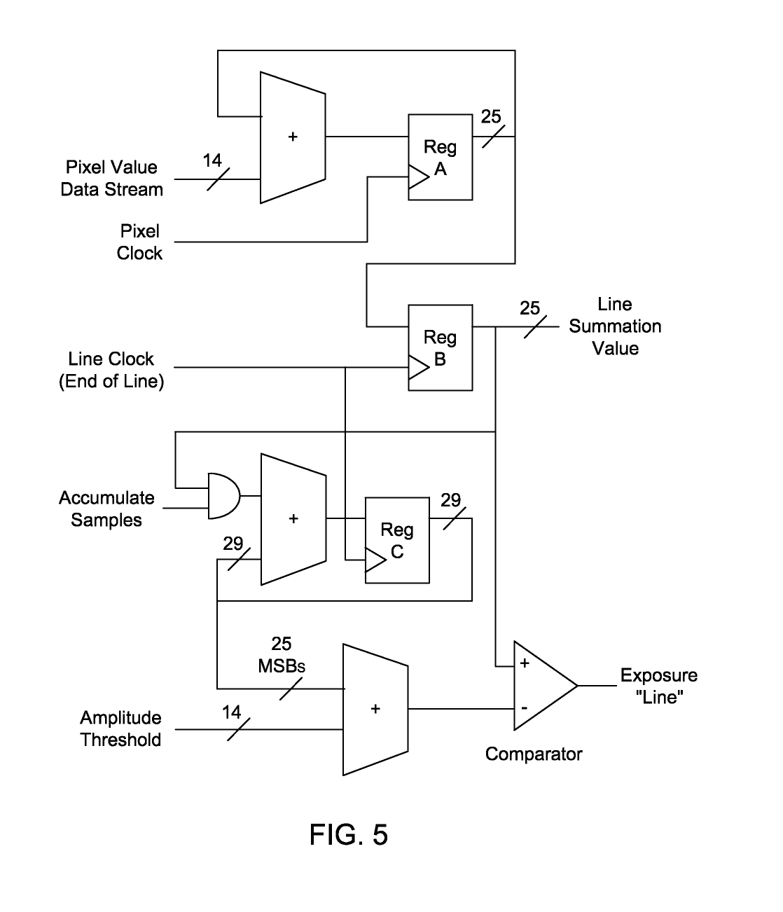

FIG. 5 is a schematic diagram of exemplary embodiment of the pixel summation and comparison logic of the digital X-ray detector 30 used in the method 86 described above. The pixels for each reading (i.e., scan line or phantom data) appear one by one on the “Pixel Value Data Stream” bus, each being 14 bits wide and being present for exactly one “Pixel Clock.” Register A (“Reg A”) then accumulates the value of all the pixels until at the end of the line, that value is transferred to Register B (“Reg B”) by virtue of the “Line Clock”. At that time, “Reg A” is reset in preparation for the next reading (i.e., scan line or phantom data). “Reg A” is 25 bits wide in order to accumulate 2048 fourteen bit values that constitute either a scan line or a single phantom reading sample of all of the readout electronics channels. At the end of each reading (i.e., scan line or phantom data), “Reg B” will contain the pixel summation for the latest line (until the end of the next line). Prior to the time that the detector 30 is generating the non-exposure baseline (block 100 in method 86), Register C (“Reg C”) will be reset. During baseline accumulation, “Accumulate Samples” will be driven high for a number of lines, which solely for the purposes of this illustration will be 16. After that time, “Accumulate Samples” goes low and stays low for the remainder of the exposure. By virtue of the fact that the 25 MSBs (Most Significant Bits) from “Reg C” are used for addition to the “Amplitude Threshold” value, the value held by “Reg C” is effectively divided by 16 and the average for the baseline accumulation, which was 16 samples, is used in the final addition. The output of the last adder feeds one side of the comparator shown. The other side of the comparator is driven by the line summation value. During the time that the detector 30 is attempting to detect an X-ray exposure, “Exposure Line” will be examined once per “line,” (or once every time all the data from every channel has been accumulated in the phantom mode) and if it is high, the last (phantom) line read by the detector 30 will have been greater than the summation of the baseline average (i.e., the non-exposure baseline) and the Amplitude Threshold, potentially indicating that the X-ray exposure was detected during that line. Note that the diagram is simplified to make it less confusing. Further, the disclosed pixel summation and comparison logic is not the only potential means of implementation of this particular concept, but only an example.

The temporal threshold (e.g., first temporal threshold) in step 118 of method 86 can be implemented in order to reduce the likelihood that an error will be made (due to noise, for example) resulting in one or a few phantom line averages being high. For example, if the minimum exposure time were expected to be 1 msec, and all of the data channels are sampled and accumulated every 100 μsec, normally one would expect that at least nine consecutive cumulative samples (i.e., “Line Summation Values”) would be above the threshold provided by the summation of the non-exposure baseline and the exposure amplitude threshold, which is the input to the “-” side of the comparator. So if only three consecutive noisy samples were above the threshold, the detector logic would reject that as evidence of exposure since that would indicate an exposure much shorter than the minimum. Other temporal thresholds are possible. In order to be tolerant of noisy samples during a low exposure, for example, perhaps the temporal threshold could be set to 7 samples out of any ten consecutive samples above the threshold to meet the criteria of minimum exposure. Also, during the phantom data read period, the line time can be shortened in order to obtain more samples for the same minimum exposure thus further reducing the probability that noisy samples will result in making the wrong decision. It must be recognized however, that changing the line time means that the integration time will also be changed, resulting in a change in signal amplitude. A similar concept is employed in step 128 of method 86, however, its value will most likely be optimized empirically.

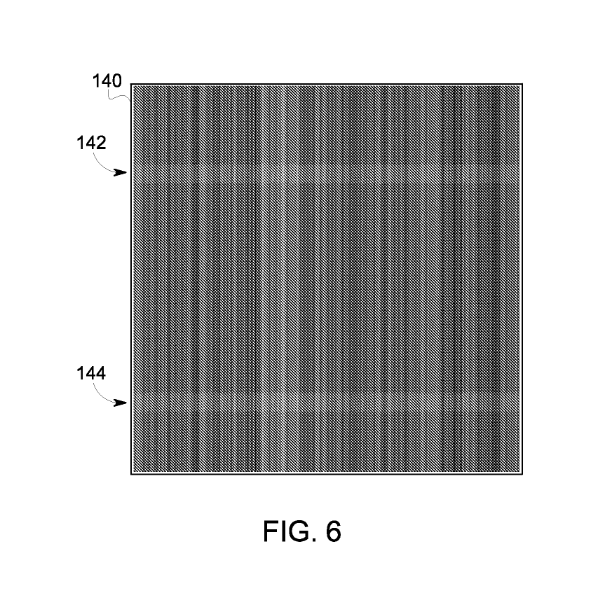

Although this concept has not yet been fully developed, some work has taken place in order to prove the feasibility of the embodiments described above. The largest risk was thought to be the ability to detect a change in the signal level as a result of the exposure when the scan circuits are held off An experiment was performed with existing hardware, software and test systems in which the scan functionality in the detector 30 was turned “off” (part of current test capability) and a generator (i.e., X-ray radiation source) was controlled to give a 10 msec, 30 uR exposure roughly every 100 msec. A sequence of images was captured from the detector 30 which was being operated asynchronously from the generator. A representation of one of the images in the captured sequence is illustrated in FIG. 6. The image 140 includes two brighter bands, represented by reference numerals 142, 144, that represent the time (and duration) of two separate exposures.

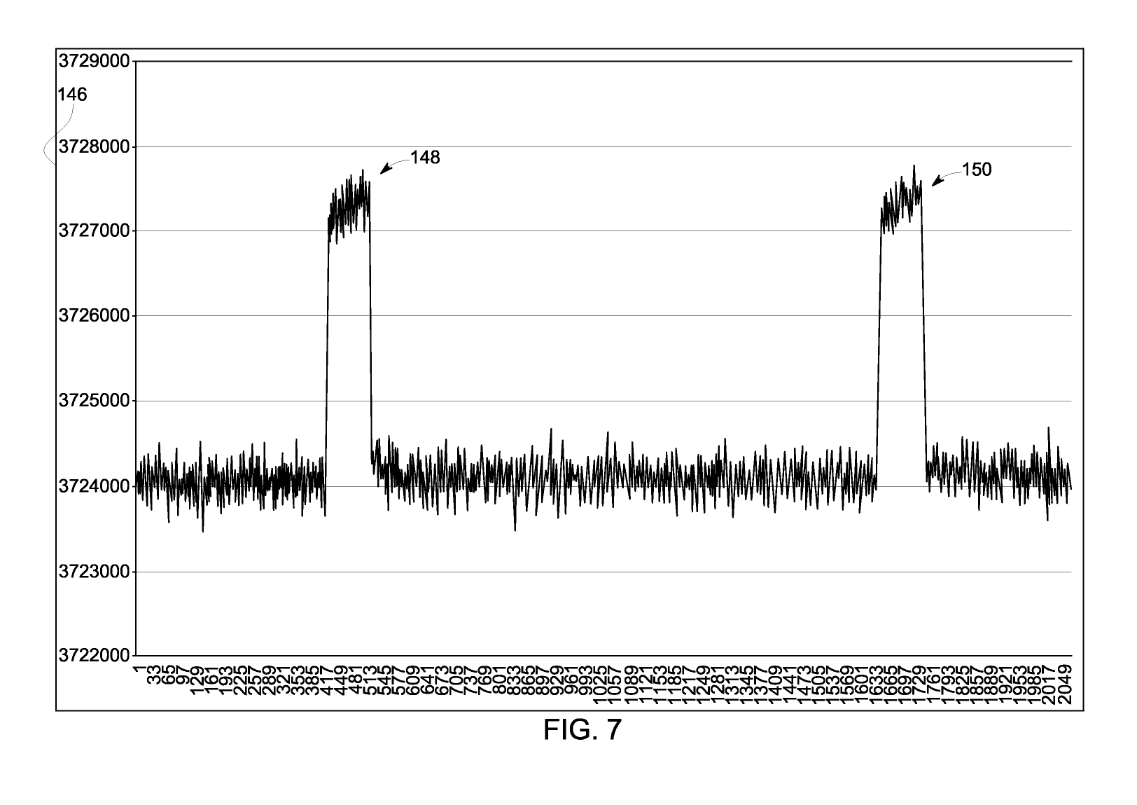

Using some crude, off line tools the data was processed similar to embodiments described above and is represented in a graph 146 illustrated in FIG. 7. For every phantom scan line (i.e. the FETs were continuously maintained in the “off state” while the readout circuits were cycled and the data was collected), all of the data channels were added to form a single number (i.e., a sum) that represents a sample of all of the data lines at that instant in time. These numbers (2048 of them, one for each phantom scan line) were then plotted point by point from left to right on the following graph 146, which in effect represents the scan line values from top to bottom in the image 140 in FIG. 6. The graph 146 includes two peaks 148, 150 that correspond to the bright bands 142, 144 in FIG. 6.

Technical effects of the disclosed embodiments include providing methods and systems to allow for the retrofitting of conventional X-ray imaging systems by replacing film and CR cassettes with the digital X-ray detector 30. In retrofitting the X-ray imaging systems 10, the digital X-ray detector 30 does not communicate with the X-ray imaging system 10. Since the detector 30 does not communicate with the X-ray imaging system 10, the digital X-ray detector 30 lacks data indicating the timing signals for an X-ray exposure. Thus, the digital X-ray detector 30 may include techniques to autonomously determine the beginning and ending of the X-ray exposure and imaging data, for example, while operating the enable circuitry and readout circuitry asynchronously.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A digital X-ray detector comprising:
a pixel array comprising a plurality of pixels arranged in two dimensions, wherein each pixel comprises a photodiode and a transistor;
a scan line coupled to each pixel in a first dimension;
a data line coupled to each pixel in the second dimension;
enable circuitry coupled to the transistor of each pixel for enabling readout of the photodiode; and
readout circuitry coupled to the photodiode through the transistor of each pixel for reading out data from the photodiode;
wherein the digital X-ray detector is configured to autonomously determine a start an X-ray exposure while the enable circuitry maintains each transistor in an off state.

2. The digital X-ray detector of claim 1, wherein the digital X-ray detector is configured to autonomously determine the start and an end of the X-ray exposure without a priori knowledge of the start and end of the X-ray exposure.

3. The digital X-ray detector of claim 1, wherein digital X-ray detector is configured to operate the enable circuitry and the readout circuitry asynchronously from each other to autonomously detect the start and an end of the X-ray exposure.

4. The digital X-ray detector of claim 1, wherein the digital X-ray detector is configured to autonomously determine the start of the X-ray exposure by cycling the readout circuitry in a powered state, and the readout circuitry is configured to readout data.

5. The digital X-ray detector of claim 4, wherein prior to an X-ray exposure the digital X-ray detector is configured to acquire phantom data from at least one data line via the readout circuitry to generate a non-exposure baseline.

6. The digital X-ray detector of claim 5, wherein the digital X-ray detector is configured to generate the non-exposure baseline by summing the phantom data from the data lines employed, when more than one data line is employed.

7. The digital X-ray detector of claim 5, wherein digital X-ray detector is configured to autonomously determine the start and an end of the X-ray exposure by comparing the level of newly acquired signal to the non-exposure baseline.

8. The digital X-ray detector of claim 7, wherein the digital X-ray detector is configured to autonomously determine the start of the X-ray exposure upon the level of the newly acquired signal being equal to or greater than an amplitude threshold above the non-exposure baseline for at least a first temporal threshold.

9. The digital X-ray detector of claim 8, wherein the digital X-ray detector is configured to autonomously determine the end of the X-ray exposure upon the level of the newly acquired signal returning to less than the amplitude threshold above the non-exposure baseline for at least a second temporal threshold.

10. The digital X-ray detector of claim 9, wherein the digital X-ray detector is configured, upon determining the end of the X-ray exposure, to operate the enable circuitry and the readout circuitry synchronously to acquire image data captured by the detector during the X-ray exposure to generate an exposure image.

11. The digital X-ray detector of claim 9, wherein the digital X-ray detector is configured to acquire an offset image subsequent to the X-ray exposure based on a length of time between the last scrub and the image read at the end of the X-ray exposure, and the offset image is used to correct the exposure image for offset.

12. An X-ray imaging system comprising:
an X-ray radiation source;
a source controller coupled to the X-ray radiation source and configured to command X-ray emission of X-ray radiation for X-ray exposures; and
a digital X-ray detector comprising:
a pixel array comprising a plurality of pixels, wherein each pixel comprises a photodiode and a transistor;
enable circuitry coupled to the transistor of each pixel for enabling readout of the photodiode; and
readout circuitry coupled to the photodiode through the transistor of each pixel for reading out data from the photodiode;
wherein the digital X-ray detector is configured to determine a start of an X-ray exposure, without communication of exposure timing signals from the source controller, while the enable circuitry maintains each transistor in an off state.

13. The X-ray imaging system of claim 12, wherein the digital X-ray detector is configured to autonomously determine the start and an end of the X-ray exposure without a priori knowledge of the start and end of the X-ray exposure.

14. The X-ray imaging system of claim 12, wherein digital X-ray detector is configured to operate the enable circuitry and the readout circuitry asynchronously from each other to autonomously detect the start and an end of the X-ray exposure.

15. The X-ray imaging system of claim 12, wherein the digital X-ray detector is configured to determine the start of the X-ray exposure by cycling the readout circuitry in a powered state, and the readout circuitry is configured to readout data.

16. The X-ray imaging system of claim 15, wherein prior to an X-ray exposure the digital X-ray detector is configured to acquire phantom data from at least one data line via the readout circuitry to generate a non-exposure baseline.

17. The X-ray imaging system of claim 16, wherein the digital X-ray detector is configured to determine the start and an end of the X-ray exposure by comparing the level of a newly acquired signal from at least one data line to the non-exposure baseline.

18. The X-ray imaging system of claim 17, wherein the digital X-ray detector is configured to determine the start of the X-ray exposure upon the level of the newly acquired signal being equal to or greater than an amplitude threshold above the non-exposure baseline for at least a first temporal threshold.

19. The X-ray imaging system of claim 18, wherein the digital X-ray detector is configured to determine the end of the X-ray exposure upon the level of the newly acquired signal returning to less than the amplitude threshold above the non-exposure baseline for at least a second temporal threshold.

20. The X-ray imaging system of claim 19, wherein the digital X-ray detector is configured, upon determining the end of the X-ray exposure, to operate the enable circuitry and the readout circuitry synchronously to acquire image data captured by the detector during the X-ray exposure to generate exposure image.

21. An X-ray imaging method comprising:
a digital X-ray detector comprising a pixel array comprising a plurality of pixels arranged in two dimensions, wherein each pixel comprises a photodiode and a transistor, a scan line coupled to each pixel in a first dimension, enable circuitry coupled to the transistor of each pixel for enabling readout of the photodiode, readout circuitry coupled to the photodiode through the transistor of each pixel for reading out data from the photodiode, and the digital X-ray detector is configured to autonomously perform the steps of:
starting a timer upon completion of scrubbing;
acquiring phantom data via the readout circuitry and generating a non-exposure baseline based on the phantom data;
upon generating the non-exposure baseline, continuing to acquire phantom data from at least one data line via the readout circuitry and determining a start and end of an X-ray exposure by comparing the level of the newly acquired signal to the non-exposure baseline;
storing a first timer value indicating the start of the X-ray exposure, if the level of the newly acquired signal is equal to or greater than an amplitude threshold above the non-exposure baseline for at least a first temporal threshold;
storing a second timer value indicating the end of the X-ray exposure, if the level of the newly acquired signal returns to less than the amplitude threshold above the non-exposure baseline for at least a second temporal threshold; and
acquiring image data captured by the detector during the X-ray exposure to generate an exposure image.

22. The method of claim 21, wherein the digital X-ray detector is configured to determine the start of the X-ray exposure while the enable circuitry maintains each transistor in an off state.

23. The method of claim 21, comprising monitoring the timer to determine if a length of the X-ray exposure beginning from the first timer value exceeds a maximum time threshold.

24. The method of claim 23, comprising, if the length of the X-ray exposure exceeds the maximum time threshold, acquiring the image data captured by the detector during the X-ray exposure for the maximum time threshold beginning with the first timer value.

25. The method of claim 21, comprising:
acquiring an offset image subsequent to the X-ray exposure based on a length of time between the last scrub and the image read at the end of the X-ray exposure;
and correcting the exposure image for offset by subtracting the offset image.
